(19) United States
(12) Patent Application Publication
(10) Pub. No.: US 2009/0058187 A1
(43) Pub. Date: Mar. 5, 2009

(54) Power supply having redundant power

(75) Inventor: Yu-Yuan Chang, Taipei Hsien (TW)

Correspondence Address: Joe McKinney Muncy, PO Box 1364, Fairfax, VA, 22038-1364, US

(73) Assignee: Zippy Technology Corp.

(21) Appl. No.: 11/896,729

(22) Filed: Sep. 5, 2007

(51) Int. Cl. H02J 7/02; H02J 7/00

(52) U.S. Cl. 307/66

(57) ABSTRACT

The present invention includes at least one power transformation device, a redundant power module to output a redundant power and an electric power distribution unit. The redundant power module includes at least an energy storage module. The power transformation device receives an input power and generates a transformed power. The power transformation device and the redundant power module are connected to the electric power distribution unit. The electric power distribution unit has a first end connecting to a power output end and a second end to receive output of the power transformation device and the redundant power module. Thereby outputs of the power transformation device and the redundant power module can be distributed to generate an output power to ensure that redundant power is provided to maintain a buffer time period in the event of power interruption or malfunction occurred to power transformation device.

### FIELD OF THE INVENTION

The present invention relates to a power supply having redundant power disposed on a power output circuit.

### BACKGROUND OF THE INVENTION

An unstable power condition of power supply during computer operation could cause abnormal system shutdown or data damage, or even damage the equipment and result in huge loss in serious conditions. To prevent such a situation from occurring computer equipments can be supported by a plurality of power supply devices to form a redundant power supply. The redundant power supply includes two or more power supply sub-system to receive an input power at the same time and provide an output voltage to drive at least one load. In the event that one sub-system malfunctions and output is abnormal, other sub-system shares all the required power, and the malfunctioned sub-system can be removed and replaced, or the remained sub-system can temporarily increase output to provide the load a buffer time to proceed normal storing and machine shutdown. Refer to FIG. 1 for a conventional redundant power supply structure. It has two power transformation devices 2 (the drawing shows a common basic structure of power supply) divided into a sub-system A and a sub-system B that are connected to a power input source 11 to receive AC power. The AC power passes through a front end commutation unit 21 and a power factor correction unit 22 to be transformed by a transformer 25 regulated by at least one switch 24 controlled by a pulse width control unit 23, then the transformed power passes through a rear end commutation unit 26 and is output to drive at least one load 6. The sub-system A and sub-system B have a rear end connecting to an output regulation unit or a load distribution unit to control output ratio of the sub-systems. As the redundant power supply previously discussed receives the input power from the same source, in the event of power interruption all the sub-systems lose the power source and stop delivering output. To overcome the disadvantage of no buffer time to protect the load during power interruption, the redundant power supply may be coupled with an uninterruptible power system (UPS) 3 as shown in FIG. 2. The conventional UPS 3 is connected to a front end of the redundant power supply and also receives city power to supply one or more power transformation device 2. In the event that the city power is not available, a battery supplies DC power with the voltage boosted, then is transformed to AC power to be output and becomes the power input source 11 of the power supply. Therefore during power interruption or unstable the power supply still can rely on the power provided by the UPS 3 to function for a selected time period. However, the conventional structures all require the power supply to deliver power, and voltage abrupt change or unstable frequently causes damage of the power supply. If the power supply was damaged due to abnormal input power, even if the UPS 3 starts operation to substitute the city power as the power source of the power supply, the damaged power supply cannot drive the load 6 normally. Hence there is still room for improvement on the conventional structures to ensure that the power supply can continuously deliver output in the event of abnormal power condition.

### SUMMARY OF THE INVENTION

In view of the aforesaid disadvantages occurred to the conventional redundant power supply and the redundant power supply coupled with a conventional UPS the primary object of the present invention is to provide a power supply having redundant power that can maintain output even if city power is interrupted or power supply devices malfunction.

The power supply having redundant power according to the invention includes at least one or more power transformation devices, at least one redundant power module to output a redundant power and an electric power distribution unit. The power transformation device receives an input power and generates a transformed power. The power transformation device is connected to the electric power distribution unit. The redundant power module and the power transformation device are coupled with the electric power distribution unit in a parallel manner. The redundant power module includes at least an energy storage module. The electric power distribution unit has one end connecting to a power output end and another end connecting to the power transformation device in regular conditions so that the transformed power is output through the power output end. Thereby the power of the power transformation device and the redundant power module are integrated to generate output power to drive at least one load. In the event that output voltage of the power transformation device is abnormal the redundant power module maintains power supply. The redundant power is output through the electric power distribution unit. By means of the structure set forth above the power transformation device and the redundant power module provide power sources to ensure that output power is available to drive the load. In the event of power interruption or malfunction occurred to the power transformation device, redundant power still is available to provide a buffer time for normal machine shutdown.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit structure block diagram of a conventional redundant power supply.

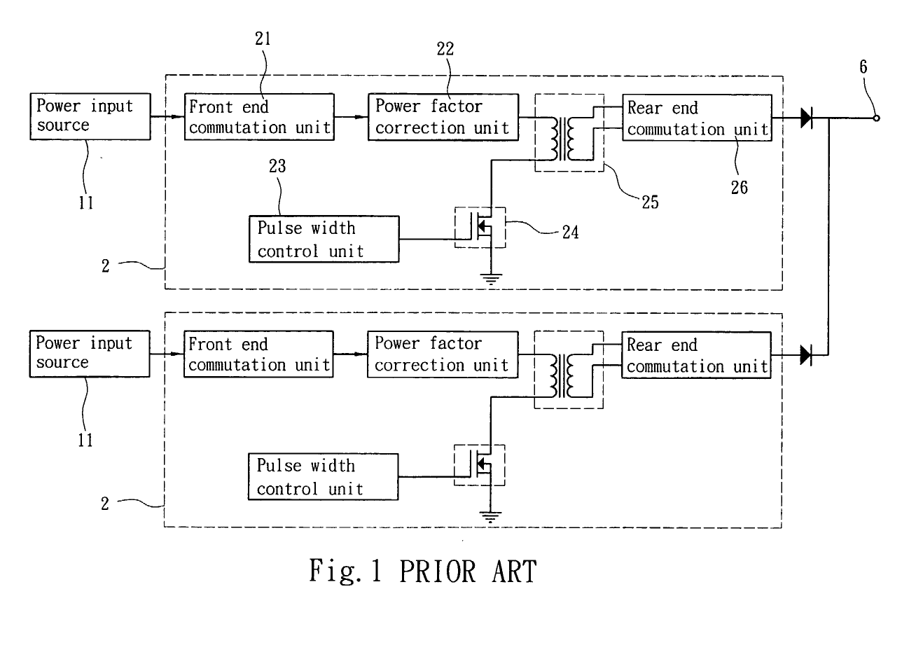

FIG. 2 is a circuit structure block diagram of a conventional redundant power supply coupled with a UPS.

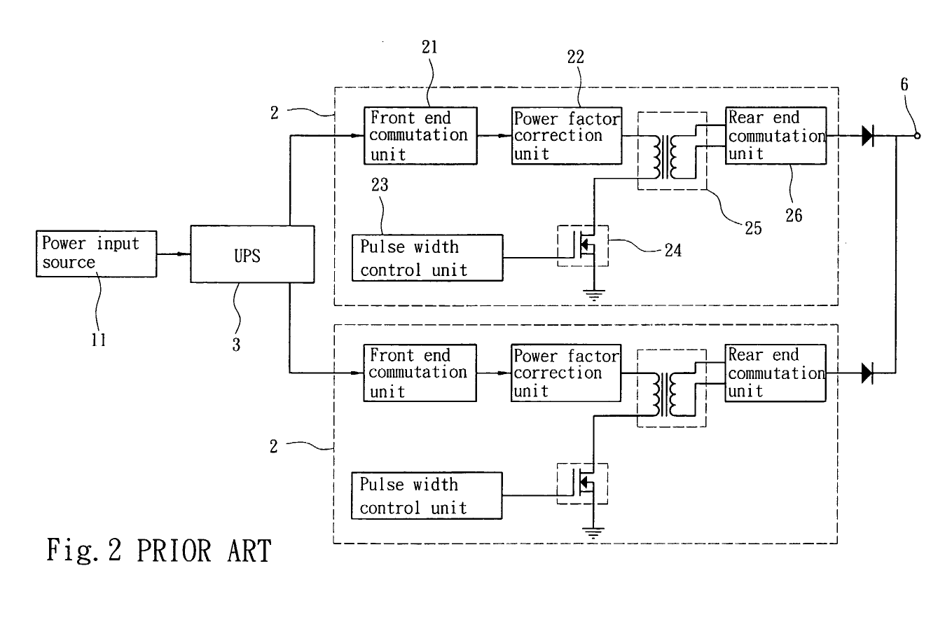

FIG. 3 is a circuit structure block diagram of the invention.

FIG. 4 is a circuit structure block diagram of an embodiment of the invention.

FIG. 5 is a circuit structure block diagram of another embodiment of the invention.

FIG. 6 is a schematic view of the embodiment according to FIG. 5.

FIG. 7 is a schematic view of another embodiment according to FIG. 5.

### DETAILED DESCRIPTION OF THE PREFERRED EMBODIMENTS

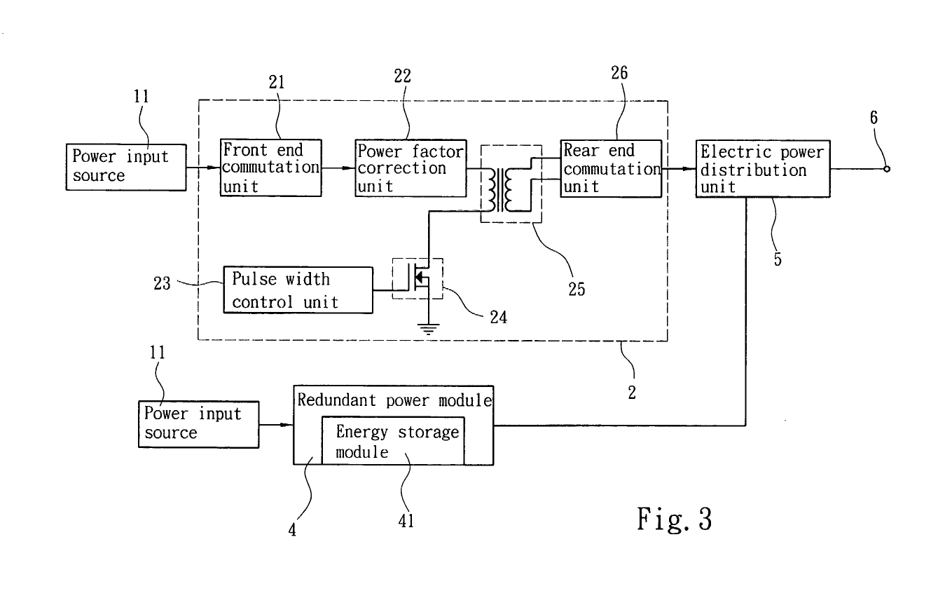

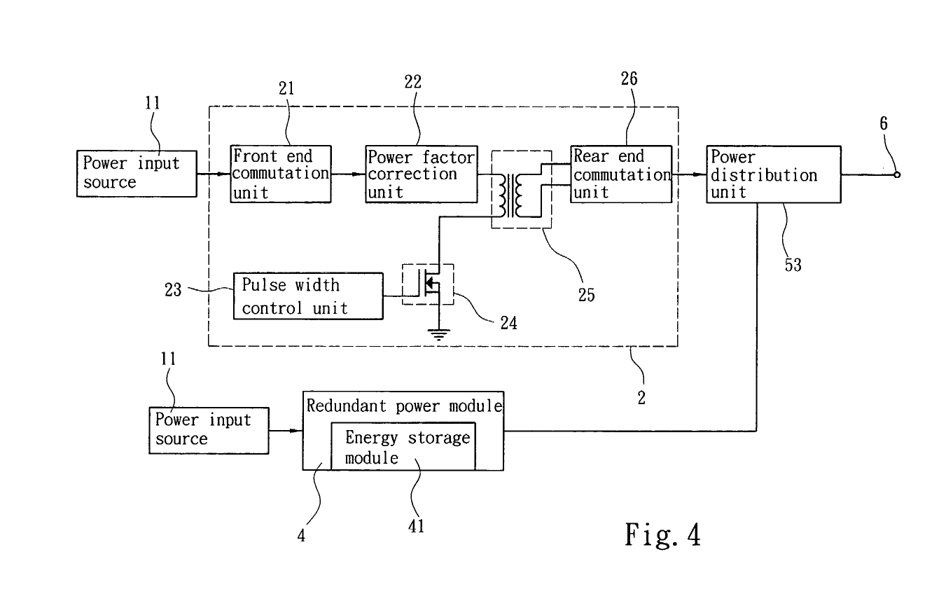

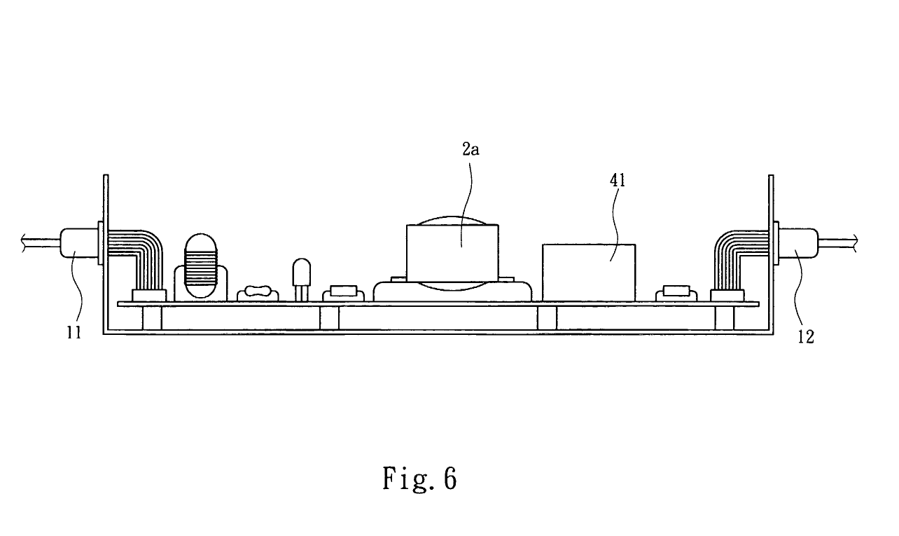

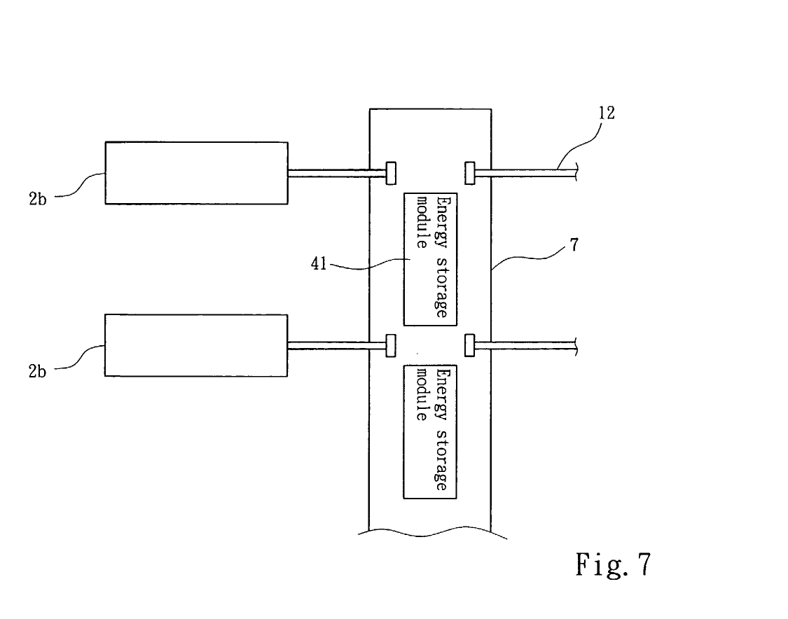

Please refer to FIG. 3 for the structure of the power supply having redundant power according to the invention. The present invention is to provide a power supply having redundant power supply The redundant power supply includes at least a power transformation device 2, a redundant power module 4 to output a redundant power and an electric power distribution unit 5. The power transformation device 2 may be a power supply device (referring to FIGS. 3, 4 and 5 for the basic structures of a power supply device). In the structure shown in FIG. 3 the power supply of the redundant power is electrically connected to an external power input source 11 and a power output end 12 (as shown in FIGS. 6 and 7) to receive an input power from the power input source 11 that is sent to the power transformation device 2 and the redundant power module 4. The power transformation device 2 receives the input power and generates a transformed power to be output to the electric power distribution unit 5. The redundant power module 4 and the power transformation device 2 are coupled to the power input source 11 in a parallel manner. The redundant power module 4 includes at least an energy storage module 41 which receives the input power in regular conditions for charging to store electric energy to generate a redundant power. The electric power distribution unit 5 has one end connecting to the power transformation device 2 and the redundant power module 4 to determine whether the output power is the transformed power or the redundant power to be sent to the power output end 12 (referring to FIGS. 6 and 7) to drive at least one load 6. In regular duty conditions the electric power distribution unit 5 may be a power distribution unit 53 to detect load utilization power and determine output power ratio of the power transformation device 2 and the redundant power module 4 (referring to FIG. 4). By detecting the output power that drives the load 6 the output power of the power transformation device 2 and the redundant power module 4 can be integrated and regulated. The electric power distribution unit 5 has at least one first circuit to set the power transformation device ON and one second circuit to set the redundant power module 4 ON so that switching can be made between the power transformation device 2 and the redundant power module 4 to select a desired output device.

Referring to FIG. 4, the electric power distribution unit 5 may be a power distribution unit 53 which receives the transformed power output from the power transformation device 2 and the redundant power output from the redundant power module 4 at the same time to generate an output power. The power distribution unit 53 can detect the power driving the load 6 and the output power of the power transformation device 2 and the redundant power module 4 to distribute output power ratio of the power transformation device 2 and the redundant power module 4. The technique and theory of power distribution are known in the art, thus are omitted herein. By means of the structures set forth above power distribution can be achieved. Moreover, in the event of malfunction occurs to one output system normal power output can still be maintained temporarily.

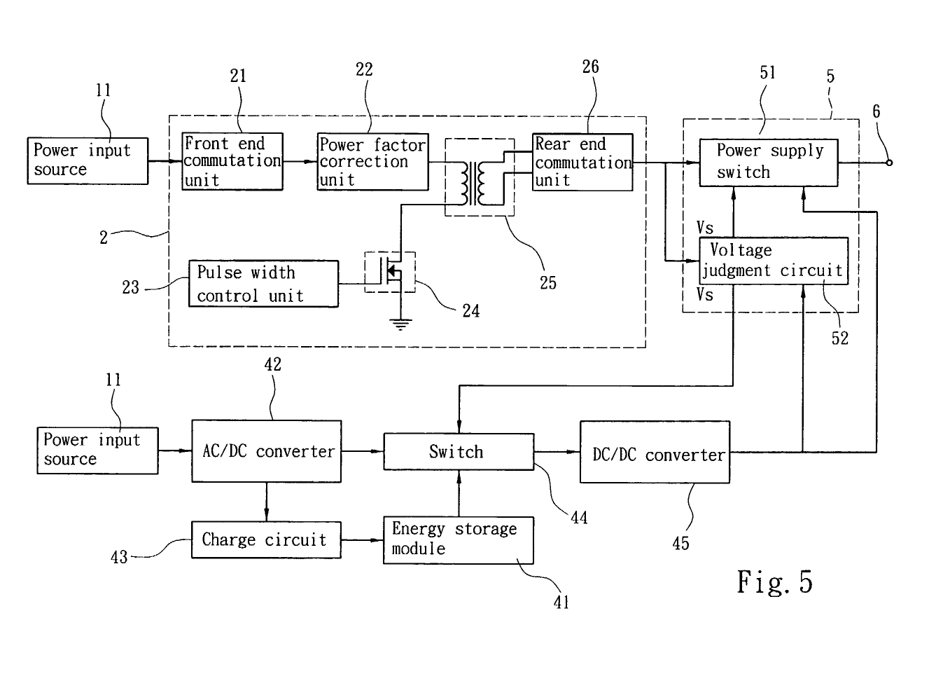

Refer to FIG. 5 for the circuit structure block diagram of another embodiment of the redundant power module 4 and electric power distribution unit 5. The redundant power module 4 includes at least an energy storage module 41, and further an AC/DC converter 42, a charge circuit 43, a switch 44 and a conversion unit. The conversion unit may be a DC/DC converter 45. The AC/DC converter 42 receives an input power from the power input source 11 and outputs DC power to the switch 44 and the charge circuit 43 which receives the DC power to charge the energy storage module 41. The switch 44 has a first end connecting to the AC/DC converter 42 in regular conditions. The AC/DC converter 42 converts the power to redundant power sent to the switch 44. The switch 44 receives a switch signal generated by the electric power distribution unit 5 and is triggered and switched to connect the energy storage module 41. The energy storage module 41 outputs the redundant power. The switch 44 has a second end connecting to the conversion unit which receives the redundant power after the switch 44 is set ON and outputs to the electric power distribution unit 5. The electric power distribution unit 5 has a switch ON circuit consisting of a power supply switch 51 and a voltage judgment circuit 52. The power supply switch 51 has a first end connecting to the power output end 12 (referring to FIGS. 6 and 7) and a second end switchable between the rear end commutation unit 26 of the power transformation device 2 and the conversion unit of the redundant power module 4. The power supply switch 51 has a second end connecting to the rear end commutation unit 26 in the regular conditions to form a first circuit to output the transformed power through the power output end 12 (referring to FIGS. 6 and 7). The power transformation device 2 generates the transformed power to be output through the power supply switch 51 and the power output end 12 (referring to FIGS. 6 and 7). The power supply switch 51 receives a switch signal Vs and is triggered to switch the second end to connect the conversion unit of the redundant power module 4 to form a second circuit to output the redundant power through the power output end 12 (referring to FIGS. 6 and 7). The redundant power module 4 generates the redundant power which is output through the power supply switch 51 and the power output end 12 (referring to FIGS. 6 and 7). The switch signal Vs is generated by the voltage judgment circuit 52 of the electric power distribution unit 5. The voltage judgment circuit 52 sets a duty voltage base value, and detects the voltage input to the power supply switch 51, and generates the switch signal Vs when the voltage of the power supply switch 51 is lower than the duty voltage base value. Hence in the regular conditions when output of the rear end commutation unit 26 connected to the second end of the power supply switch 51 is lower than the duty voltage base value the voltage judgment circuit 52 generates the switch signal Vs sent to the power supply switch 51 to switch the second end thereof to connect the conversion unit of the redundant power module 4. The redundant power module 4 provides the redundant power to maintain operation of the load 6. The voltage judgment circuit 52 has a judgment mechanism to set the duty voltage base value through a voltage source, and through at least a comparator to compare the transformed power and redundant power with the duty voltage base value, and determine whether the transformed power and the redundant power is higher than the duty voltage base value. In the event that either of them is lower than the duty voltage base value the switch signal Vs is generated. The circuit of the comparator is known in the art, thus details are omitted herein. The voltage judgment circuit 52 may further set a voltage difference base value and get the voltage difference between the transformed power and the redundant power. In the event that the voltage of either of them drops and becomes lower than the other a voltage difference is formed. When the voltage difference is greater than the voltage difference base value the switch signal Vs is generated. Such a technique also is known in the art, thus details are omitted herein.

Refer to FIG. 6 for a schematic view of an embodiment of the invention. The power supply may be a single power supply device connecting to at least one power input source 11, and is connected to at least one load 6 (not shown in the drawing) through the power output end 12. The power supply device includes required electronic elements and a power transformation device 2a to transform input power. The power transformation device 2a may be a transformer. The layout of the redundant power module 4 may be built in the circuit of the power supply device, and include at least one energy storage module 41 which contains one or more battery. FIG. 7 depicts a schematic view of another embodiment of the invention. The power supply may include at least one power transformation device 2b coupled in parallel to a power integration panel 7. The power transformation device 2b is a power supply device. The layout of the electric power distribution unit 5 may be built on the power integration panel 7. The layout of the redundant power module 4 also may be built on the power integration panel 7. The energy storage module 41 is connected to the power integration panel 7. The circuit structures and embodiments set forth above can overcome the disadvantages occurred to the conventional redundant power supply, and provide a safer power interruption protection measure.

While the preferred embodiments of the invention have been set forth for the purpose of disclosure, they shall not be deemed as the limitation of the invention. For instance, the AC/DC converter 42 in the redundant power module may be substituted by a DC/DC converter to be compatible with DC power input. Modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply having redundant power being electrically connected to an external power input source to transform an input power to an output power to drive at least one load through at least one power output end, comprising:
at least one power transformation device connecting to the power input source to receive the input power and generate a transformed power;
at least one redundant power module which is coupled with the power input source in parallel with the power transformation device which also is coupled with the power input source, and includes at least one energy storage module which receives the input power in regular conditions to store electric energy to generate a redundant power; and
at least one electric power distribution unit which is connected to the power transformation device and the redundant power module and determines whether the output power is the transformed power or the redundant power sent to the power output end.

2. The power supply of claim 1, wherein the power supply is a single power supply device and the power transformation device is a transformer of the power supply device, the energy storage module being one or more battery.

3. The power supply of claim 1, wherein the power supply includes a plurality of power supply devices and at least one power integration panel, and the power transformation device includes at least one power supply device, the energy storage module being installed on the power integration panel.

4. The power supply of claim 1, wherein the electric power distribution unit is a power distribution unit which detects load utilization power and determines output power ratio of the power transformation device and the redundant power module.

5. The power supply of claim 1, wherein the electric power distribution unit is a conduction switch circuit which includes at least a first circuit to set the power transformation device ON and a second circuit to set the redundant power module ON.

6. The power supply of claim 5, wherein the conduction switch circuit further includes a power supply switch and a voltage judgment circuit, the power supply switch having a first end connecting to the power output end and a second end connecting to the power transformation device in the regular conditions to form the first circuit to allow the transformed power to be output through the power output end, the voltage judgment circuit generating a switch signal representing an abnormal output voltage of the power transformation device to control switching and connection of the second end of the power supply switch to the redundant power module to form the second circuit to provide the redundant power through the power output end.

7. The power supply of claim 6, wherein the redundant power module includes an AC/DC converter which receives the input power from the power input source and transforms and outputs a DC power, the energy storage module, a charge circuit to receive the DC power to charge the energy storage module, a switch to receive the switch signal and be triggered to bridge the AC/DC converter and the energy storage module, and a conversion unit to convert power after the switch is conductive to the redundant power output to the electric power distribution unit.

8. The power supply of claim 7, wherein the conversion unit is a DC/DC converter.

9. The power supply of claim 6, wherein the redundant power module includes an DC/DC converter which receives the input power from the power input source and transforms and outputs a DC power, the energy storage module, a charge circuit to receive the DC power to charge the energy storage module, a switch to receive the switch signal and be triggered to bridge the DC/DC converter and the energy storage module, and a conversion unit to convert power after the switch is conductive to the redundant power output to the electric power distribution unit.

10. The power supply of claim 9, wherein the conversion unit is a DC/DC converter.
